(19) United States
(12) Patent Application Publication
(10) Pub. No.: US 2024/0412890 A1
(43) Pub. Date: Dec. 12, 2024

(54) METHOD OF MANUFACTURING WIRE COVERING MATERIAL FOR PREVENTION OF SPILLOVER LOSS DURING TRANSMISSION OF HIGH FREQUENCY SIGNAL

(71) Applicant: TRUSVAL TECHNOLOGY CO., LTD., MIAOLI COUNTY (TW)

(72) Inventor: SHIH-PAO CHIEN, MIAOLI COUNTY (TW)

(21) Appl. No.: 18/812,197

(22) Filed: Aug. 22, 2024

Related U.S. Application Data
(63) Continuation-in-part of application No. 17/661,403, filed on Apr. 29, 2022, now abandoned.

(51) Int. Cl. H01B 3/12; B29B 7/90; B29C 71/02; B29K 105/00; B29K 509/02

(52) U.S. Cl. CPC H01B 3/12; B29B 7/90; B29C 71/02; B29C 2071/022; B29K 2105/0094; B29K 2509/02; B29K 2995/0097

(57) ABSTRACT

A method of manufacturing wire covering materials for prevention of spillover loss during transmission of high frequency signals is revealed. First mixing high insulating ceramic materials having flake structure with polymers and then forming a functional dielectric layer with no gap, no micropore, and a dielectric constant of less than or equal to 2.5 by a manufacturing process. Thereby the dielectric layer is used to cover various types of wires, or connector plugs and sockets for prevention of spillover loss during transmission of high frequency signals.

### CROSS-REFERENCE TO RELATED APPLICATION

This is a continuation-in-part of the U.S. patent application Ser. No. 17/661,403, filed on Apr. 29, 2022 and owned by the present applicant.

### BACKGROUND OF THE INVENTION

### Field of the Invention

The present invention relates to a method of manufacturing wire covering materials for prevention of spillover loss during transmission of high frequency signals, especially to a method of manufacturing wire covering materials for prevention of spillover loss during transmission of high frequency signals by using a functional dielectric layer to cover various types of wires, or connector plugs and sockets.

### Description of Related Art

Along with prosperous development of high technology, the size of passive electronic components is minimized, becoming more intense per unit area, and having higher performance. Thus requirements for quality of passive electronic components are increasing year by year.

A passive electronic component does not generate power, but it has the effect of dissipate, store, and/or release electricity. Examples of passive electronic components are capacitors, resistors, inductors, and so on. The passive electronic components are connected with active electronic components to form a complete circuit. For insulation, wires and connectors used for connection the passive electronic components with the active electronic components are covered in plastic materials.

Although the plastic materials mentioned above are widely used to form coatings around various types of wires and connectors for insulation and protection, they cause significant spillover loss during transmission of high frequency signals.

Thus there is room for improvement and there is a need to provide novel materials for prevention of spillover loss during transmission of high frequency signals.

### SUMMARY OF THE INVENTION

Therefore, it is a primary object of the present invention to provide a method of manufacturing wire covering materials for prevention of spillover loss during transmission of high frequency signals by using a functional dielectric layer to cover various types of wires, or connector plugs and sockets.

In order to achieve the above object, a primary object of the present invention to provide a method of manufacturing wire covering materials for prevention of spillover loss during transmission of high frequency signals according to the present invention includes the following steps.

A. getting ceramic materials having flake structure: getting high insulating ceramic materials having flake structure in nano-scale. The flake structure has a flake diameter ranging from 0.5 μm to 10 μm and contains 1 to 10 layers each of which having a thickness of 1 nm-3 nm;

B. mixing: mixing the ceramic materials having the flake structure with polymers;

C. obtaining functional dielectric layer: forming a functional dielectric layer with no gap, no micropore, and a dielectric constant of less than or equal to 2.5 by a manufacturing process.

Preferably, the flake structure of the high insulating ceramic materials is cubic crystal or pseudocubic crystal.

Preferably, in-situ mixing of the ceramic materials having the flake structure with non-polar polymers, or mixing of the ceramic materials having the flake structure with polymers is performed.

Preferably, mixing of the flake structure with the polymers is carried out by a mixer to get a mixture.

Preferably, a solid content of the mixture contains at least 50% the high insulating ceramic materials having the flake structure.

Preferably, the mixture of the ceramic materials having the maximum diameter of 60 nm with a non-polar dispersant treated by ball milling dispersion for at least 8 hours.

Preferably, the mixture is formed by the ceramic materials having a flake diameter ranging from 110 nm to 1500 nm mixed with a non-polar dispersant and then treated by ball milling dispersion for at least 3 hours.

Preferably, the functional dielectric layer is gotten by the manufacturing process of coating.

Preferably, the functional dielectric layer is gotten by the manufacturing process of blow molding.

Preferably, the functional dielectric layer is gotten by the manufacturing process of die casting.

Preferably, the functional dielectric layer is gotten by the manufacturing process of injection molding.

Preferably, the functional dielectric layer is made of a polymer material.

Preferably, viscosity of the mixture for manufacturing the functional dielectric layer is adjusted by solvents according to requirements for applications to form a film. A thickness of the film formed after curing is at least 6 μm while an initial temperature of curing the film is 100° C.-200° C. and the initial temperature is maintained at least one minute.

Preferably, an optimal initial temperature of curing the film is 150° C.

Preferably, the ceramic material is montmorillonite.

Preferably, the ceramic material is boron nitride.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart showing steps of an embodiment according to the present invention;

FIG. 2 is a schematic drawing showing a lateral sectional view of an embodiment while in use according to the present invention.

### DETAILED DESCRIPTION OF THE PREFERRED EMBODIMENT

In order to learn technical features and functions of the present invention, please refer to the following embodiments with detailed descriptions, related figures and reference signs.

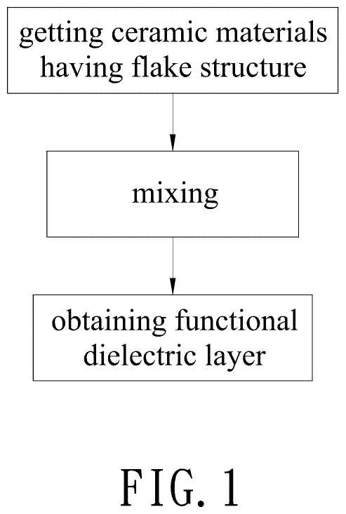

Refer to FIG. 1, a method of manufacturing wire covering materials for prevention of spillover loss during transmission of high frequency signals includes the following steps.

A. getting ceramic materials having flake structure: getting high insulating ceramic materials having flake structure in nano-scale while the flake structure can be cubic crystal or pseudocubic crystal. The ceramic material can be either montmorillonite or boron nitride. The flake structure has a flake diameter ranging from 0.5 μm to 10 μm and contains 1 to 10 layers while the optimal flake diameter is 5 μm and 1-3 layers are preferred. A thickness of the respective layers of the flake structure is 1 nm-3 nm and 1.5 nm-2 nm is preferred.

B. mixing: performing in-situ mixing of the flake structure with non-polar polymers or uniformly mixing the flake structure with polymers by a mixer to form a mixture, which can be in the form of a paste, granulation, or plastic pellets. The polymer can be a liquid crystal plastic (LCP). A solid content of the mixture contains at least 50% the high insulating ceramic materials having the flake structure while 98% is preferred. The mixture is prepared by mixing the ceramic materials having the maximum diameter of 60 nm with a non-polar dispersant treated by ball milling dispersion for at least 8 hours while 10 hours are preferred. Or the mixture is formed by the ceramic materials having a flake diameter ranging from 110 nm to 1500 nm mixed with a non-polar dispersant and then treated by ball milling dispersion for at least 3 hours while 4 hours are preferred. The optimal flake diameter of the ceramic materials is ranging from 960 nm to 1100 nm.

C. obtaining functional dielectric layer: forming a functional dielectric layer with no gap, no micropore, and a dielectric constant of less than or equal to 2.5 by a manufacturing process such as coating, blow molding, die casting, injection molding, and so on. The functional dielectric layer is made of a polymer material, and added material is a multi-layer structure material in nano-scale. The functional dielectric layer is prepared by mixing different materials with functions required at certain ratios and then adjusting viscosity of the mixture by solvents according to requirements for applications to form a film. The formed film is cured through a heating process. In the first stage, the film is heated to 35° C.-45° C. for 2 minutes. It then enters the second stage, where it is heated to 65° C.-80° C. for 3 minutes, followed by the third stage, where the temperature is increased to 100° C.-120° C. for 2 minutes. After the film has dried and solidified, it is wound and placed into an annealing furnace for post-treatment. The initial temperature in the annealing furnace is 100° C.-150° C., where it is maintained for at least 10 hours before being allowed to cool naturally to room temperature. Thereby the film formed after curing has a thickness of at least 6 μm and an initial temperature of curing the film is 100° C.-200° C. which is maintained for at least one minute. The optimal initial temperature is 150° C.

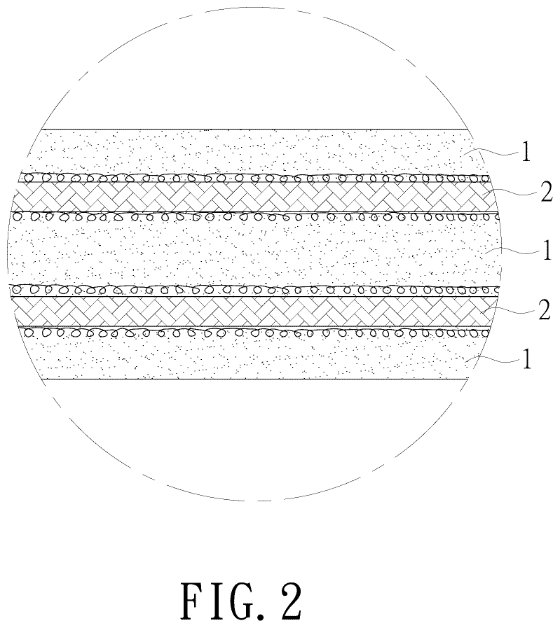

Refer to FIG. 2, a side view of a section of an embodiment is revealed. The functional dielectric layer 1 can be used to cover wires 2 such as Type C 3.0, Type C 3.5, Type C 4.5 and so on, or applied to wrapping of connector (such as RJ45) plugs and sockets. The functional dielectric layer 1, in the form of a film on a contact surface with the wires 2, has a duty ratio which is higher than average value of insulating materials so as to prevent spillover loss during transmission of high frequency signals ranging from 3.5 GHz to 20 GHz.

In summary, compared with the techniques available now, the present method is more practical in use by using the dielectric layer to cover various types of wires, or connector plugs and sockets for prevention of spillover loss during transmission of high frequency signals.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A method of manufacturing wire covering materials for prevention of spillover loss during transmission of high frequency signals comprising steps of:
getting ceramic materials having flake structure: getting high insulating ceramic materials having nano-scale flake structure with a flake diameter ranging from 0.5 μm to 10 μm and the flake structure contains 1 to 10 layers each of which having a thickness of 1 nm-3 nm;
mixing: mixing of the ceramic materials having the flake structure with polymers;
obtaining functional dielectric layer: forming a functional dielectric layer with no gap, no micropore, and a dielectric constant of less than or equal to 2.5 by at least one manufacturing process.

2. The method as claimed in claim 1, wherein the flake structure of the high insulating ceramic materials is cubic crystal or pseudocubic crystal.

3. The method as claimed in claim 1, wherein in-situ mixing of the ceramic materials having the flake structure with non-polar polymers, or mixing of the ceramic materials having the flake structure with polymers is performed.

4. The method as claimed in claim 1, wherein the mixing of the ceramic materials having the flake structure with the polymers is performed by a mixer to get a mixture.

5. The method as claimed in claim 4, wherein a solid content of the mixture contains at least 50% the high insulating ceramic materials having the flake structure.

6. The method as claimed in claim 4, wherein the mixture of the ceramic materials having the maximum diameter of 60 nm with a non-polar dispersant treated by ball milling dispersion for at least 8 hours.

7. The method as claimed in claim 4, wherein the paste is gotten by the ceramic materials having a flake diameter ranging from 110 nm to 1500 nm mixed with a non-polar dispersant and then treated by ball milling dispersion for at least 3 hours.

8. The method as claimed in claim 1, wherein the functional dielectric layer is obtained by the manufacturing process of coating.

9. The method as claimed in claim 1, wherein the functional dielectric layer is obtained by the manufacturing process of blow molding.

10. The method as claimed in claim 1, wherein the functional dielectric layer is obtained by the manufacturing process of die casting.

11. The method as claimed in claim 1, wherein the functional dielectric layer is obtained by the manufacturing process of injection molding.

12. The method as claimed in claim 1, wherein the functional dielectric layer is made of a polymer material.

13. The method as claimed in claim 1, wherein viscosity of the mixture used for obtaining the functional dielectric layer is adjusted by solvents according to requirements for applications to form a film; a thickness of the film formed after curing is at least 6 μm while an initial temperature of curing the film is 100° C.-200° C. and the initial temperature is maintained for at least one minute.

14. The method as claimed in claim 13, wherein an optimal initial temperature of curing the film is 150° C.

15. The method as claimed in claim 1, wherein the ceramic material is montmorillonite.

16. The method as claimed in claim 1, wherein the ceramic material is boron nitride.
